(19) United States
(12) Patent Application Publication
(10) Pub. No.: US 2017/0194694 A1
(43) Pub. Date: Jul. 6, 2017

(54) DUAL-BAND WI-FI ANTENNA AND MOBILE TERMINAL

(71) Applicants: LE HOLDINGS (BEIJING) CO., LTD., Beijing (CN); LEMOBILE INFORMATION TECHNOLOGY (BEIJING) CO., LTD., Beijing (CN)

(72) Inventor: Biao LI, Beijing (CN)

(21) Appl. No.: 15/242,047

(22) Filed: Aug. 19, 2016

Related U.S. Application Data
(63) Continuation of application No. PCT/CN2016/088672, filed on Jul. 5, 2016.

(30) Foreign Application Priority Data
Jan. 6, 2016 (CN) 2016100090562

(51) Int. Cl. H01Q 1/24; H01Q 9/04; H01Q 9/06; H01Q 5/30; H01Q 1/22; H01Q 1/48

(52) U.S. Cl. CPC H01Q 1/243; H01Q 1/2291; H01Q 1/48; H01Q 9/065; H01Q 5/30; H01Q 9/0421

(57) ABSTRACT

A dual-frequency WI-FI antenna and a mobile terminal are provided. The dual-frequency WI-FI antenna comprises: a first single-frequency antenna arranged on a mobile terminal mainboard, wherein the first single-frequency antenna comprises a ground portion and a feed portion, the ground portion is electrically connected to a ground line on the mobile terminal mainboard, and the feed portion is electrically connected to a radio frequency chip on the mobile terminal mainboard. The dual-frequency WI-FI antenna also comprises a micro-strip line arranged around the feed portion, wherein the micro-strip line is electrically connected to the ground line on the mobile terminal mainboard, and the micro-strip line and the feed portion are coupled to generate resonance radiation of a WI-FI second single-frequency antenna.

### CROSS REFERENCE TO RELATED APPLICATIONS

The present application is a continuation of PCT application which has an application number of PCT/CN2016/088672 and was filed on Jul. 5, 2016. This application claims the priority of Chinese Patent Application No. 201610009056.2, entitled “Double-frequency WI-FI Antenna and Mobile Terminal”, filed with China Patent Office on Jan. 6, 2016, which is incorporated herein by reference in its entirety.

### TECHNICAL FIELD

This application relates to the technical field of antennas, and more particularly to a dual-frequency WI-FI antenna and a mobile terminal.

### BACKGROUD

WI-FI (Wireless Fidelity) is widely applied to mobile terminals, such as WI-FI cell phones. As compared to Bluetooth technology that has been previously applied to mobile terminals, WI-FI has larger coverage and higher transmission speed, and thus WI-FI mobile terminals have become a trend in the mobile communication industry.

As WI-FI frequency bands are free and do not need telecommunication license worldwide, WLAN (Wireless Local Area Networks) wireless devices provide a wireless air interface that is available worldwide and has extremely-low costs and extremely-high data bandwidth. A user can browse webpages quickly and make or receive calls at all times and places within a WI-FI covered area. And other WLAN-based wideband data applications, such as streaming media or network games and other functionalities, are worth pursuing. With the WI-FI function, a user can make long-distance calls (including international direct dialing), browse webpages, send and receive e-mails, download music and transfer digital photos without the need to worry about slow speed and high fees.

In the relevant existing WI-FI antenna design, dual-frequency (i.e. 2.4 GHz and 5 GHz) full-band coverage is implemented through the conventional antenna types, such as PIFA (Planar Inverted-F Antenna), monopole or IFA (Inverted-F antenna), thereby achieving better bandwidth and radiation efficiency and meeting use requirements of customers.

However, this dual-frequency WI-FI antenna design has the problems as follows: such dual-frequency WI-FI antenna needs relatively-large space area and clearance area, which brings insoluble bottlenecks to complete-machine architectural consistency and PCB (Printed Circuit Board) layout.

### SUMMARY

To this end, this application provides a dual-frequency WI-FI antenna and a mobile terminal, in which a micro-strip line is arranged around a built-in WI-FI single-frequency antenna in the mobile terminal to generate resonance radiation of another single-frequency antenna by means of coupling, so as to solve the above problems.

In accordance with one aspect of this application, a dual-frequency WI-FI antenna is provided, comprising: a first single-frequency antenna arranged on a mobile terminal mainboard, the first single-frequency antenna comprising a ground portion and a feed portion, the ground portion being electrically connected to a ground line on the mobile terminal mainboard, the feed portion being electrically connected to a radio frequency chip on the mobile terminal mainboard; and a micro-strip line arranged around the feed portion, the micro-strip line being electrically connected to the ground line on the mobile terminal mainboard, the micro-strip line and the feed portion being coupled to generate resonance radiation of a WI-FI second single-frequency antenna.

In accordance with another aspect of this application, a mobile terminal is provided, comprising a mainboard and a dual-frequency WI-FI antenna; wherein the dual-frequency WI-FI antenna comprises a first single-frequency antenna arranged on the mainboard; the first single-frequency antenna comprises a ground portion and a feed portion, the ground portion is electrically connected to a ground line on the mainboard, and the feed portion is electrically connected to a radio frequency chip on the mainboard; the dual-frequency WI-FI antenna also comprises a micro-strip line arranged around the feed portion, the micro-strip line is electrically connected to the ground line on the mobile terminal mainboard, and the micro-strip line and the feed portion are coupled to generate resonance radiation of a second single-frequency antenna.

The dual-frequency WI-FI antenna provided by an example of this application comprises: a first single-frequency antenna arranged on a mobile terminal mainboard, the first single-frequency antenna comprises a ground portion and a feed portion, the ground portion is electrically connected to a ground line on the mobile terminal mainboard, and the feed portion is electrically connected to a radio frequency chip on the mobile terminal mainboard, wherein the dual-frequency WI-FI antenna also comprises a micro-strip line arranged around the feed portion, the micro-strip line is electrically connected to the ground line on the mobile terminal mainboard, and the micro-strip line and the feed portion are coupled to generate resonance radiation of a WI-FI second single-frequency antenna. The space area for single-frequency WI-FI meets the requirement of dual-frequency antenna design, which greatly saves the space area for a dual-frequency WI-FI antenna and reduces the clearance area. Meanwhile, the parasitic resonance is generated by means of coupling, which reduces the susceptibility of the antenna to surrounding environments and the requirement for environment consistency during complete-machine assembly, and effectively shortens the complete-machine production time.

### BRIEF DESCRIPTION OF THE DRAWINGS

One or more embodiments is/are accompanied by the following figures for illustrative purposes and serve to only to provide examples. These illustrative descriptions in no way limit any embodiments. Similar elements in the figures are denoted by identical reference numbers. Unless it states the otherwise, it should be understood that the drawings are not necessarily proportional or to scale.

FIG. 1 is a schematic view showing an outer surface of a cell phone rear cover of an example of this application;

FIG. 2 is a schematic view showing a cell phone built-in printed circuit board of another example of this application.

### DETAILED DESCRIPTION

Exemplary examples of this disclosure will be described below in greater detail with reference to the accompanying drawings. Although the exemplary examples of this disclosure are shown in the drawings, it should be understood that this disclosure may be implemented in various forms and should not be limited by the examples set forth herein. On the contrary, these examples are provided to enable this disclosure to be understood more clearly, and may present the entire scope of this disclosure to those skilled in the art.

Term description:

Micro-strip line: a microwave transmission line formed by a single conductor strip supported on a medium substrate.

Parasitic capacitance: in a sensor, besides capacitance between pole plates, there is also a capacitance generated between a pole plate and a peripheral body (various elements, and even a human body), which is referred to as the parasitic capacitance. It may change the capacitance of a capacitance sensor, and since the sensor itself has a small capacitance, parasitic capacitance is extremely unstable, resulting in performance instability of the sensor and thus causing severe disturbance to the sensor. The distributed capacitances, such as those distributed between wires, between coils and casings and between some elements, are referred to as parasitic capacitance. Although they are small in value, they still are major causes to disturbance.

Parasitic inductance: due to increasing frequency, the influence of lead parasitic inductance and parasitic capacitance is worsened, leading to a larger electric stress on the device, featured by overvoltage and overcurrent burrs.

Parasitic resonance: under the parasitic effect of elements, resonance phenomena occur at more frequencies in a resonant circuit, which are referred to as parasitic resonance.

In the examples of this application, based on the space of a single-frequency antenna of the original WI-FI, the performance of a dual-frequency WI-FI antenna (such as, 2.4 G+5 G) is implemented through the method in which parasitic resonance is generated through the coupling of a micro-strip, without the need to add additional antenna space and clearance area.

The technical solution of this application will be illustrated below by taking a cell phone as an instance. It should be noted that a mobile terminal in this application is not limited to cell phones, and may be other devices, such as panel computers or other devices applied to Wi-Fi antennas to implement wireless communication.

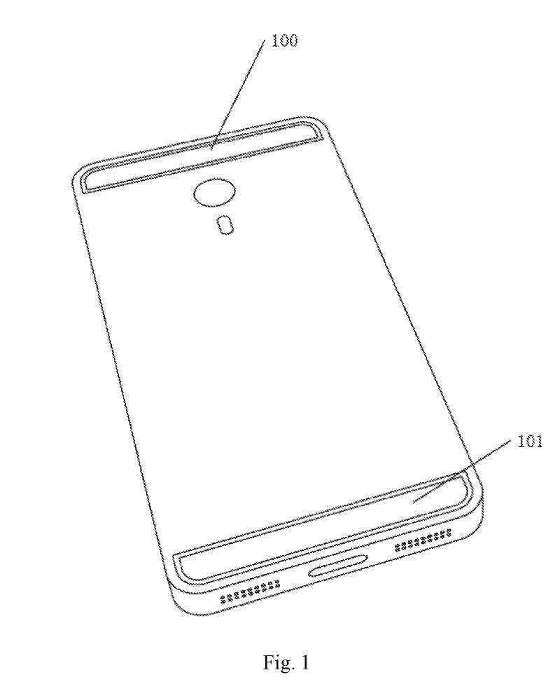

FIG. 1 is a schematic view showing an outer surface of a cell phone rear cover of an example of this application. Radiators corresponding to a cell phone WI-FI antenna in this example are indicated as 100 and 101. By arranging feed points at the respective positions corresponding to 100 and/or 101 of an inner surface of a cell phone metal rear cover, it is possible for 100 and/or 101 to act as radiators of a cell phone antenna. The radiators may be located above, below or in the middle position of the cell phone rear cover, and there is no limit to this.

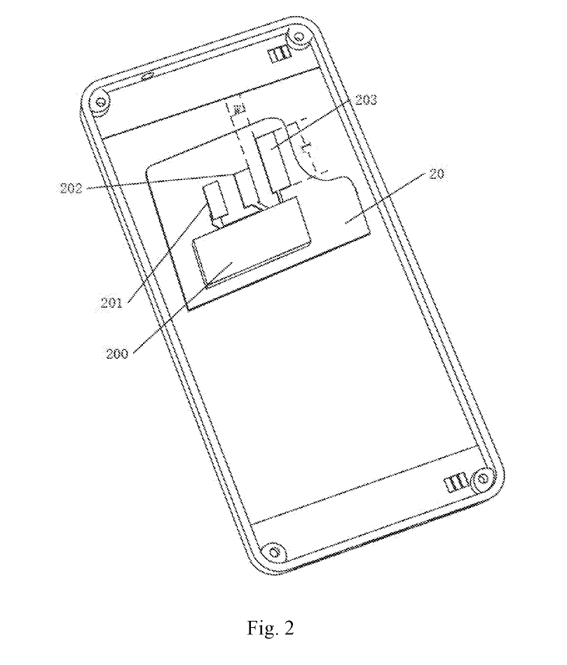

FIG. 2 is a schematic view showing a cell phone built-in printed circuit board of another example of this application. Here, a PCB plate is indicated as 20, a radio frequency chip of PCB is indicated as 200, and the radio frequency chip combines with a cell phone antenna to transmit and receive electromagnetic signals. A ground portion and a feed portion of a 2.4 G single-frequency antenna are indicated as 201 and 202, the ground portion 201 is electrically connected to a ground line (not shown) of the PCB plate, the feed portion 202 is electrically connected to a radio frequency chip 200 of the PCB plate, a micro-strip line is indicated as 203, and the micro-strip line 203 is electrically connected to the ground portion 201 of the PCB plate. By coupling the micro-strip line 203 to the feed portion 202, the original resonant frequency of the WI-FI 2.4 G single-frequency antenna can be expanded, thus achieving the operating effect of a WI-FI 5 G single-frequency antenna.

In an alternative example, the WI-FI 2.4 G single-frequency antenna is a PIFA antenna. At present, monopole, LOOP or PIFA antennas are commonly used as WI-FI antennas in cell phones. Since a PIFA antenna needs a space area smaller than that of a LOOP antenna but larger than that of a monopole antenna, relatively stable performances and relatively high transmission efficiency, it is more widely used in different types of cell phones.

By regulating the spacing width between the feed portion 202 and the micro-strip line 203, the key parameters of the antenna, such as antenna resonance bandwidth, radiation efficiency and matching impedance, can be effectively controlled, thereby achieving good antenna radiation efficiency and improving transmission efficiency. It is proved by practical experience that the arrangement of spacing between the feed portion 202 and the micro-strip line 203 is conducive to coupling effects.

In an alternative example, when the above spacing width is 1.5 mm-2 mm (including 1.5 mm and 2 mm), the coupling effect is better.

Furthermore, by regulating the length of the micro-strip line, the magnitudes of coupling area and electromagnetic induction between the micro-strip line 203 and the feed portion 202 can be regulated to achieve the purpose of performing bandwidth shift, enabling the resulting resonant frequency to be within the 5 G WI-FI frequency range (i.e. 5.15 GHz to 5.875 GHz) and broadening the resonant frequency range (i.e. antenna bandwidth) to the greatest extent.

In an alternative example, the length of the micro-strip line 203 is set as one-quarter wavelength of the operating frequency of a first single-frequency antenna.

According to the examples of this application, based on the original capacity of a WI-FI 2.4 G single-frequency antenna, the performance of a WI-FI dual-frequency (2.4 G+5 G) antenna is implemented through the method in which parasitic resonance is generated through the coupling of the micro-strip line, without the need to add additional antenna capacity and clearance area. Also, by regulating the length L of the micro-strip line, the purpose of bandwidth shift is achieved, and the modulation of the spacing W between the micro-strip line and the feed portion can optimize and broaden the antenna bandwidth and achieve good matching, thereby improving the transmission efficiency.

Furthermore, the examples of this application implement spatial separation of a resonator and a radiator of a dual-frequency antenna. For example, the resonance of a WI-FI 5 G single-frequency antenna is generated by a micro-strip line, and for the radiation performance, space radiation is implemented by the common cell phone casing. In this manner, in the case of harsh exterior environments, the radiation performance of the WI-FI 5 G single-frequency antenna remains good.

In accordance with the dual-frequency WI-FI antenna mentioned above, a mobile terminal is provided, comprising a mainboard, wherein the mobile terminal also comprises a dual-frequency WI-FI antenna, and the dual-frequency WI-FI antenna comprises a first single-frequency antenna arranged on the mainboard; the first single-frequency antenna comprises a ground portion and a feed portion, the ground portion is electrically connected to a ground line on the mainboard, and the feed portion is electrically connected to a radio frequency chip on the mainboard; wherein the dual-frequency WI-FI antenna also comprises a micro-strip line arranged around the feed portion, the micro-strip line is electrically connected to the ground line on the mobile terminal mainboard, and the micro-strip line and the feed portion are coupled to generate resonance radiation of a second single-frequency antenna.

In an alternative example, the first single-frequency antenna is a WI-FI 2.4 G single-frequency antenna, and the second single-frequency antenna is a WI-FI 5 G single-frequency antenna.

In another alternative example, the spacing between the feed portion and the micro-strip line is 1.5 mm-2 mm.

In yet another alternative example, the length of the micro-strip line is one-quarter wavelength of the operating frequency of the first single-frequency antenna.

In the examples of this application, the space area for single-frequency WI-FI meets the requirement of dual-frequency antenna design, which greatly saves the space area for dual-frequency WI-FI antennas and reduces the clearance area; the antenna and PA are well matched by optimizing the gap distance, which reduces BOM costs; meanwhile, the parasitic resonance is generated by means of coupling, which reduces the susceptibility of the antenna to the surrounding environment and the requirement for environment consistency during complete-machine assembly, and effectively shortens the complete-machine production time.

The foregoing is merely illustrative of preferred examples of this application and not intended to limit this application, and it is apparent for those skilled in the art that various modifications and variations may be made to this application. All the modifications, equivalent replacements, improvements and the like that are made without departing from the spirit and principle of this application should fall within the scope of this application.

1-10. (canceled)

11. A dual-frequency WI-FI antenna comprising:
a first single-frequency antenna arranged on a mobile terminal mainboard, the first single-frequency antenna comprising a ground portion and a feed portion, the ground portion being electrically connected to a ground line on the mobile terminal mainboard, the feed portion being electrically connected to a radio frequency chip on the mobile terminal mainboard; and
a micro-strip line arranged around the feed portion, the micro-strip line being electrically connected to the ground line on the mobile terminal mainboard, the micro-strip strip line and the feed portion being coupled to generate resonance radiation of a WI-FI second single-frequency antenna.

12. The dual-frequency WI-FI antenna according to claim 11, wherein the first single-frequency antenna is a WI-FI 2.4 G single-frequency antenna and the second single-frequency antenna is a WI-FI 5 G single-frequency antenna.

13. The dual-frequency WI-FI antenna according to claim 11, wherein the spacing between the feed portion and the micro-strip line is 1.5 mm-2 mm.

14. The dual-frequency WI-FI antenna according to claim 11, wherein the length of the micro-strip line is one-quarter wavelength of the operating frequency of the first single-frequency antenna.

15. The dual-frequency WI-FI antenna according to claim 12, wherein the 2.4 G single-frequency antenna is a planar inverted-F antenna (PIFA).

16. The dual-frequency WI-FI antenna according to any one of claim 11, wherein the rear cover of the mobile terminal acts as a radiator of the dual-frequency WI-FI antenna.

17. The dual-frequency WI-FI antenna according to claim 12, wherein the rear cover of the mobile terminal acts as a radiator of the dual-frequency WI-FI antenna.

18. The dual-frequency WI-FI antenna according to claim 13, wherein the rear cover of the mobile terminal acts as a radiator of the dual-frequency WI-FI antenna.

19. The dual-frequency WI-FI antenna according to claim 14, wherein the rear cover of the mobile terminal acts as a radiator of the dual-frequency WI-FI antenna.

20. The dual-frequency WI-FI antenna according to claim 15, wherein the rear cover of the mobile terminal acts as a radiator of the dual-frequency WI-FI antenna.

21. A mobile terminal comprising:
a mainboard;
a dual-frequency WI-FI antenna, wherein the dual-frequency WI-FI antenna comprises a first single-frequency antenna arranged on the mainboard; the first single-frequency antenna comprises a ground portion and a feed portion, the ground portion is electrically connected to a ground line on the mainboard, and the feed portion is electrically connected to a radio frequency chip on the mainboard; the dual-frequency WI-FI antenna also comprises a micro-strip line arranged around the feed portion, the micro-strip line is electrically connected to the ground line on the mobile terminal mainboard, and the micro-strip line and the feed portion are coupled to generate resonance radiation of a second single-frequency antenna.

22. The mobile terminal according to claim 21, wherein the first single-frequency antenna is a WI-FI 2.4 G single-frequency antenna and the second single-frequency antenna is a WI-FI 5 G single-frequency antenna.

23. The mobile terminal according to claim 21, wherein the spacing between the feed portion and the micro-strip line is 1.5 mm-2 mm.

24. The mobile terminal according to claim 21, wherein the length of the micro-strip line is one-quarter wavelength of the operating frequency of the first single-frequency antenna.

25. The mobile terminal according to claim 22, wherein the 2.4 G single-frequency antenna is a planar inverted-F antenna (PIFA).

26. The mobile terminal according to claim 21, wherein the rear cover of the mobile terminal acts as a radiator of the dual-frequency WI-FI antenna.

27. The mobile terminal according to claim 22, wherein the rear cover of the mobile terminal acts as a radiator of the dual-frequency WI-FI antenna.

28. The mobile terminal according to claim 23, wherein the rear cover of the mobile terminal acts as a radiator of the dual-frequency WI-FI antenna.

29. The mobile terminal according to claim 24, wherein the rear cover of the mobile terminal acts as a radiator of the dual-frequency WI-FI antenna.

30. The mobile terminal according to claim 25, wherein the rear cover of the mobile terminal acts as a radiator of the dual-frequency WI-FI antenna.
